(19) United States
(12) Patent Application Publication
(10) Pub. No.: US 2023/0266137 A1
(43) Pub. Date: Aug. 24, 2023

(54) SYSTEMS AND METHODS FOR RECOMMENDING POINTS OF INTEREST

(71) Applicant: BEIJING DIDI INFINITY TECHNOLOGY AND DEVELOPMENT CO., LTD., Beijing (CN)

(72) Inventors: Qian LIU, Beijing (CN); Mingquan CHEN, Beijing (CN); Chao SHEN, Beijing (CN)

(73) Assignee: BEIJING DIDI INFINITY TECHNOLOGY AND DEVELOPMENT CO., LTD., Beijing (CN)

(21) Appl. No.: 18/308,667

(22) Filed: Apr. 27, 2023

Related U.S. Application Data
(63) Continuation of application No. PCT/CN2020/124035, filed on Oct. 27, 2020.

(51) Int. Cl. G01C 21/34; G01C 21/36

(52) U.S. Cl. CPC G01C 21/3476; G01C 21/3682; G01C 21/3617

(57) ABSTRACT

The present disclosure relates to systems and methods for displaying one or more points of interest (POIs) of a location-based service (LBS). The method may include receiving a request for an LBS sent by a user via a user terminal and obtaining a start location based on the request for the LBS. The method may also include determining one or more recommended POIs based on the start location and POI data associated with the start location. Further, the method may also include transmitting signals to the user terminal to display at least one of the one or more recommended POIs.

### CROSS-REFERENCE TO RELATED APPLICATIONS

This application is a Continuation of International Application No. PCT/CN2020/124035, filed on Oct. 27, 2020, the contents of which are hereby incorporated by reference.

### TECHNICAL FIELD

The present disclosure generally relates to location-based services (LBSs), and more specifically, relates to systems and methods for providing recommendations for one or more points of interest (POIs).

### BACKGROUND

Conventionally, when a user initiates a vehicle-hailing request near to or within an area or building (e.g. a gated community) having a plurality of gateways (e.g., entrances, exits), a service platform determines a recommended POI for the vehicle-hailing request based on current POI data. Since the current POI data usually only includes a POI representing the area or building (also referred to as “parent POI”), the recommended POI points to the parent POI, which is often inconvenient to the user as a pick-up location. In some cases, a child POI, which represents a gateway, would be more appropriate as the pick-up location. For example, when the child POI is relatively closer to the user and more accessible than the parent POI, it would often be more convenient for the user to use the child POI. However, when the parent POI is selected as the pick-up location, the user often needs to walk a longer distance to the parent POI, or to communicate with the driver of the vehicle to adjust the pick-up location, thus worsening user experience. Therefore, it is desirable to provide systems and methods for efficiently and accurately recommending a pick-up location for a user.

### SUMMARY

According to one aspect of the present disclosure, a system configured to display one or more points of interest (POIs) of a location-based service (LBS) may be provided. The system may include at least one storage medium including a set of instructions; and at least one processor in communication with the at least one storage medium. When executing the set of instructions, the at least one processor may be directed to: receive a request for an LBS sent by a user via a user terminal; obtain a start location based on the request for the LBS; determine one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and transmit signals to the user terminal to display at least one of the one or more recommended POIs.

In some embodiments, the POI data associated with the start location may be provided by: obtaining a plurality of historical transportation trip records, wherein each of the plurality of historical transportation trip records includes a historical start location of a historical user, a historical location of the historical user, one or more historical POIs, and a selected historical POI as a historical service location of the historical transportation trip record; determining a plurality of groups of historical POIs based on the historical start locations and the historical POIs, wherein each group of the plurality of groups of historical POIs includes a historical parent POI within a historical region and one or more historical child POIs within the historical region; determining an initial historical popularity degree corresponding to each historical POI at least based on the selected historical POIs corresponding to the plurality of historical transportation trip records; adjusting at least one of the initial historical popularity degrees corresponding to at least one historical POI based on one or more historical transportation trip records whose selected historical POIs are historical parent POIs among the plurality of historical transportation trip records and generating at least one adjusted historical popularity degree; and determining the POI data associated with the start location based on the plurality of group of historical POIs, the initial historical popularity degrees, and the at least one adjusted historical popularity degree.

In some embodiments, the adjusting at least one of the initial historical popularity degrees corresponding to at least one historical POI of the plurality of groups of historical POIs based on one or more historical transportation trip records whose selected historical POIs are historical parent POIs among the plurality of historical transportation trip records and generating at least one adjusted historical popularity degree may include: for each of the one or more historical transportation trip records, determining one or more distances between a historical location of a historical user and one or more historical child POIs; and determining a historical child POI with a smallest distance of the one or more distances; determining a count of each of the one or more historical child POIs with the smallest distance; and generating the at least one adjusted historical popularity degree based on the count of the one or more child POIs with the smallest distance.

In some embodiments, the POI data associated with the start location may further include at least one POI other than the parent POI and the one or more child POIs associated with the region and at least one popularity degree corresponding to the at least one POI of each of the plurality of groups of POIs.

In some embodiments, the POI data associated with the start location may further include feature information of each of the plurality of groups of POIs.

In some embodiments, the at least one processor may be further directed to: obtain one or more supplementary groups of POIs; and add the one or more supplementary groups of POIs to the plurality of groups of POIs.

In some embodiments, to recommend the one or more POIs based on the current location and POI data associated with the start location, the at least processor may be directed to: determine a plurality of candidate POIs based on the start location; rank at least a portion of the candidate POIs to produce a ranking result at least based on the POI data associated with the start location; and determine the one or more recommended POIs based on the ranking result.

In some embodiments, to rank at least a portion of the candidate POIs to produce a ranking result at least based on the POI data associated with the start location, the at least one processor may be further directed to: obtain a current location of the user; obtain a distance between the current location and each of the at least a portion of the candidate POIs; rank the at least a portion of the candidate POIs to produce a ranking result based on the POI data associated with the start location and the distances.

In some embodiments, the at least a portion of candidate POIs may include one of the parent POIs and at least one child POI corresponding to the parent POI. The at least one processor may be further directed to: rank the at least a portion of the candidate POIs to produce a ranking result based on the POI data associated with the start location and the distances. The at least one processor may be directed to: determine whether at least one distance between the current location and at least one of the at least one child POI is smaller than a distance threshold and to generate a determination result; and rank the at least a portion of the candidate POIs to produce the ranking result based on the determination result and the POI data associated with the start location.

In some embodiments, the determination result may include the at least one distance between the current location and the at least one of the at least one child POI being smaller than the distance threshold. To rank the at least a portion of the candidate POIs to produce the ranking result based on the determination result and the POI data associated with the start location, the at least one processor may be further directed to: allocate at least one weight to the at least one of the at least one child POI; and rank the at least a portion of the candidate POIs to produce the ranking result at least based on the at least one weight and the POI data associated with the start location.

In some embodiments, the at least one processor may be further directed to receive signals indicating that one of the one or more recommend POIs is selected as a pick-up location for the request for the LBS by the user.

According to another aspect of the present disclosure. a method may be provided. The method may be implemented on a computing device having at least one processor, at least one storage medium, and a communication platform connected to a network. The method may include: receiving a request for an LBS sent by a user via a user terminal; obtaining a start location based on the request for the LBS; determining one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and transmitting signals to the user terminal to display at least one of the one or more recommended POIs.

In some embodiments, the POI data associated with the start location may be provided by: obtaining a plurality of historical transportation trip records, wherein each of the plurality of historical transportation trip records includes a historical start location of a historical user, a historical location of the historical user, one or more historical POIs, and a selected historical POI as a historical service location of the historical transportation trip record; determining a plurality of groups of historical POIs based on the historical start locations and the historical POIs, wherein each group of the plurality of groups of historical POIs includes a historical parent POI within a historical region and one or more historical child POIs within the historical region; determining an initial historical popularity degree corresponding to each historical POI at least based on the selected historical POIs corresponding to the plurality of historical transportation trip records; adjusting at least one of the initial historical popularity degrees corresponding to at least one historical POI based on one or more historical transportation trip records whose selected historical POIs are historical parent POIs among the plurality of historical transportation trip records and generating at least one adjusted historical popularity degree; and determining the POI data associated with the start location based on the plurality of group of historical POIs, the initial historical popularity degrees, and the at least one adjusted historical popularity degree.

In some embodiments, the adjusting at least one of the initial historical popularity degrees corresponding to at least one historical POI of the plurality of groups of historical POIs based on one or more historical transportation trip records whose selected historical POIs are historical parent POIs among the plurality of historical transportation trip records and generating at least one adjusted historical popularity degree may include: for each of the one or more historical transportation trip records, determining one or more distances between a historical location of a historical user and one or more historical child POIs; and determining a historical child POI with a smallest distance of the one or more distances; determining a count of each of the one or more historical child POIs with the smallest distance; and generating the at least one adjusted historical popularity degree based on the count of the one or more child POIs with the smallest distance.

In some embodiments, the POI data associated with the start location may further include at least one POI other than the parent POI and the one or more child POIs associated with the region and at least one popularity degree corresponding to the at least one POI of each of the plurality of groups of POIs.

In some embodiments, the POI data associated with the start location may further include feature information of each of the plurality of groups of POIs.

In some embodiments, the method may further include: obtaining one or more supplementary groups of POIs; and adding the one or more supplementary groups of POIs to the plurality of groups of POIs.

In some embodiments, the recommending the one or more POIs based on the current location and POI data associated with the start location may include: determining a plurality of candidate POIs based on the start location; ranking at least a portion of the candidate POIs to produce a ranking result at least based on the POI data associated with the start location; and determining the one or more recommended POIs based on the ranking result.

In some embodiments, the ranking at least a portion of the candidate POIs to produce a ranking result at least based on the POI data associated with the start location may include: obtaining a current location of the user; obtaining a distance between the current location and each of the at least a portion of the candidate POIs; and ranking the at least a portion of the candidate POIs to produce a ranking result based on the POI data associated with the start location and the distances.

In some embodiments, the at least a portion of candidate POIs may include one of the parent POIs and at least one child POI corresponding to the parent POI. The method may further include ranking the at least a portion of the candidate POIs to produce a ranking result based on the POI data associated with the start location and the distances. The method may include: determining whether at least one distance between the current location and at least one of the at least one child POI is smaller than a distance threshold and to generate a determination result; and ranking the at least a portion of the candidate POIs to produce the ranking result based on the determination result and the POI data associated with the start location.

In some embodiments, the determination result may include the at least one distance between the current location and the at least one of the at least one child POI being smaller than the distance threshold. The ranking the at least a portion of the candidate POIs to produce the ranking result based on the determination result and the POI data associated with the start location may include: allocating at least one weight to the at least one of the at least one child POI; and ranking the at least a portion of the candidate POIs to produce the ranking result at least based on the at least one weight and the POI data associated with the start location.

In some embodiments, the method may further include receiving signals indicating that one of the one or more recommend POIs is selected as a pick-up location for the request for the LBS by the user.

According to another aspect of the present disclosure, a non-transitory computer readable medium may be provided. The non-transitory computer readable medium may include executable instructions that, when executed by at least one processor, a method may be performed. The method may include: receiving a request for an LBS sent by a user via a user terminal; obtaining a start location based on the request for the LBS; determining one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and transmitting signals to the user terminal to display at least one of the one or more recommended POIs.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary location based service (LBS) system according to some embodiments of the present disclosure;

FIG. 2 is a schematic diagram illustrating exemplary hardware and/or software components of a computing device on which a processing device may be implemented according to some embodiments of the present disclosure;

FIG. 3 is a schematic diagram illustrating exemplary hardware and/or software components of a mobile device on which one or more terminals may be implemented according to some embodiments of the present disclosure;

FIG. 4 is a schematic block diagram illustrating an exemplary processing device according to some embodiments of the present disclosure;

FIG. 5 is a flowchart illustrating an exemplary process for displaying one or more points of interest (POIs) of a location-based service (LBS) according to some embodiments of the present disclosure;

FIG. 6 is a flowchart illustrating an exemplary process for determining POI data associated with a start location according to some embodiments of the present disclosure; and

FIG. 7 is a schematic diagram of exemplary POI data according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods in the present disclosure are described primarily regarding recommending one or more POIs of an LBS, it should also be understood that this is only one exemplary embodiment. The systems and methods in the present disclosure may be applied to any application scenario in which a user initiates a request for an LBS. In some embodiments, the systems and methods of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The systems and methods of the present disclosure may be applied to taxi hailing, chauffeur services, delivery service, carpool, bus service, take-out service, driver hiring, vehicle hiring, bicycle sharing service, train service, subway service, shuttle services, location service, map service, or the like. The application of the system or method of the present disclosure may include a webpage, a plug-in of a browser, a client terminal, a custom system, an internal analysis system, an artificial intelligence robot, or the like, or any combination thereof.

An aspect of the present disclosure relates to systems and methods for determining one or more recommended POIs for an LBS. In addition, the present disclosure also relates to displaying at least one of the one or more recommended POIs via the user terminal. The LBS may include a start location of the LBS. In response to the start location, the systems and methods may determine the one or more recommended POIs based at least on the start location and POI data associated with the start location. Further, the systems and methods may transmit a signal to the user terminal to display at least one of the one or more recommended POIs. The user may select one of the at least one of the one or more recommended POIs as a pick-up location for the LBS.

In the disclosure, the POI data associated with the start location may include a plurality of groups of POIs and a popularity degree corresponding to each of the plurality of groups of POIs. Each group of POIs may at least include a parent POI within a region and one or more child POIs within the region. The POI data associated with the start location may be determined at least based on a plurality of historical transportation trip records. For some of the plurality of historical transportation trip records, historical child POIs may be unlikely to be recommended as historical pick-up locations. However, some of the historical child POIs may be more appropriate as the historical pick-up locations than corresponding historical parent POIs. Accordingly, the systems and methods may increase historical popularity degrees corresponding to some of the historical child POIs. The popularity degree corresponding to each POI may be determined at least based on the increased historical popularity degrees. According to the POI data associated with the start location, the systems and methods may determine the one or more recommended POIs accurately, which may be efficient for the user and a service provider (e.g., a driver).

It should be noted that while the start location and the pick-up location are used as examples for the present disclosure, the optimization of other types of locations can also utilize the methods and systems herein disclosed. For example, an LBS service may include a destination, the systems and methods may determine a drop-off location based on the POI data associated with the destination.

It should also be noted that the present disclosure takes the POI data used in vehicle-hailing scenarios as an example, the POI data may be also used in other application scenarios similar to current POI data. For example, the POI data may be used for route planning, navigation, etc.

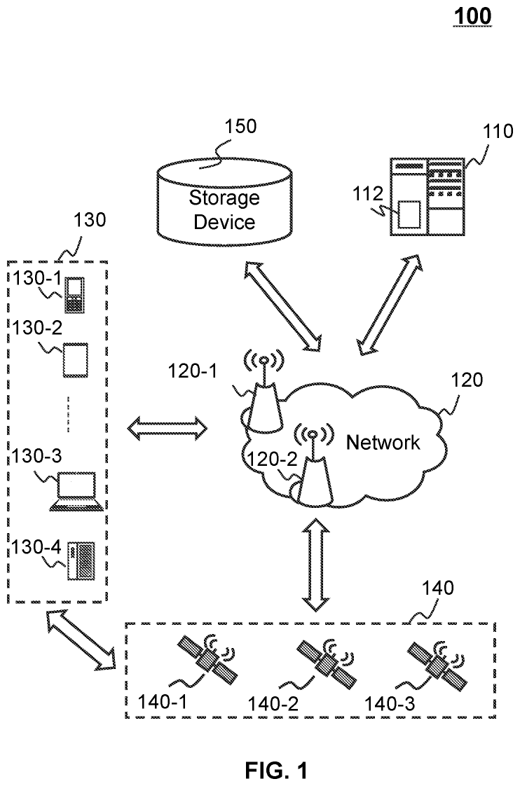

FIG. 1 is a schematic diagram of an exemplary LBS system 100 according to some embodiments of the present disclosure. The LBS system 100 may include a server 110, a network 120, a user terminal 130, a positioning system 140, and a storage device 150. An LBS refers to any service related to location information (e.g., a pick-up location, a drop-off location). Exemplary LBSs may include a transportation service (for example, a taxi-hailing service, a chauffeur service, an express car service, a carpool service, a bus service, a driver hire service, and a shuttle service), a post service, a food order service, a take-away service, a navigation service, a location search service, a location input service, a positioning service, or the like, or any combination thereof.

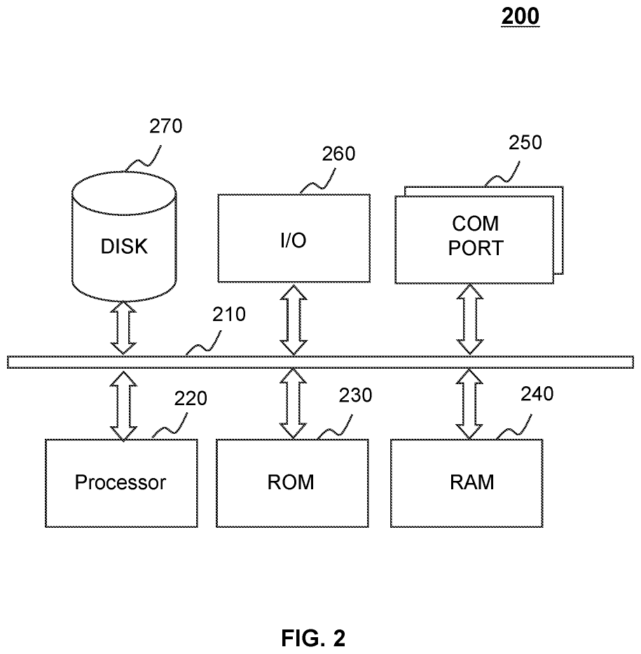

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in a user terminal (e.g., the user terminal 130), and/or the storage device 150 via the network 120. As another example, the server 110 may be directly connected to the user terminal (e.g., the user terminal 130), and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data to perform one or more functions described in the present disclosure. For example, the processing device 112 may determine one or more recommended POIs for a user of the user terminal 130. In some embodiments, the processing device 112 may include one or more processing devices (e.g., single-core processing device(s) or multi-core processor(s)). Merely by way of example, the processing device 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the LBS system 100 (e.g., the server 110, the user terminal 130, the storage device 150, and the positioning system 140) may send information and/or data to other component(s) in the LBS system 100 via the network 120. For example, the processing device 112 may obtain a plurality of historical transportation trip records from the storage device 150, and/or the user terminal 130 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the LBS system 100 may be connected to the network 120 to exchange data and/or information.

In some embodiments, a service requester may be a user of the user terminal 130. In some embodiments, the user of the user terminal 130 may be someone other than the service requester. For example, a user A of the user terminal 130 may use the user terminal 130 to send a service request for a user B, or receive service and/or information or instructions from the server 110. In some embodiments, “service requester,” “requester,” and “requester terminal” may be used interchangeably.

In some embodiments, the user terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, the built-in device in the motor vehicle 130-4 may include an onboard computer, an onboard television, etc. In some embodiments, the user terminal 130 may be a device with positioning technology for locating the position of the service requester and/or the user terminal 130.

The positioning system 140 may determine location information associated with an object. For example, the positioning system 140 may determine a location of the user terminal 130 in real-time. In some embodiments, the positioning system 140 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as latitude coordinate and longitude coordinate, etc. The positioning system 140 may include one or more satellites, for example, a satellite 140-1, a satellite 140-2, and a satellite 140-3. The satellites 140-1 through 140-3 may determine the location information mentioned above independently or jointly. The satellite positioning system 140 may send the information mentioned above to the network 120, or the user terminal (e.g., the user terminal 130) via wireless connections.

The storage device 150 may store data and/or instructions. In some embodiments, the storage device 150 may store data obtained from the user terminal 130 and/or the server 110. For example, the storage device 150 may store a plurality of historical transportation trip records. In some embodiments, the storage device 150 may store data and/or instructions that the server 110 may execute or use to perform exemplary methods described in the present disclosure. For example, the storage device 150 may store instructions that the processing device 112 may execute to determine one or more POIs for the user of the user terminal 130. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the LBS system 100 (e.g., the server 110, the user terminal 130, and/or the positioning system 140). One or more components in the LBS system 100 may access the data or instructions stored in the storage device 150 via the network 120. In some embodiments, the storage device 150 may be directly connected to or communicate with one or more components in the LBS system 100 (e.g., the server 110, the user terminal 130, the positioning system 140). In some embodiments, the storage device 150 may be part of the server 110.

FIG. 2 is a schematic diagram illustrating exemplary hardware and software components of a computing device 200 on which the server 110, the user terminal 130 may be implemented according to some embodiments of the present disclosure. For example, the processing device 112 may be implemented on the computing device 200 and configured to perform functions of the processing device 112 disclosed in this disclosure.

The computing device 200 may be a special purpose computer in some embodiments. The computing device 200 may be used to implement an LBS system for the present disclosure. The computing device 200 may implement any component of the LBS system as described herein. In FIGS. 1-2, only one such computer device is shown purely for convenience purposes. One of ordinary skill in the art would understand at the time of filing of this application that the computer functions relating to the LBS as described herein may be implemented in a distributed fashion on a number of similar platforms, to distribute the processing load.

The computing device 200, for example, may include a communication (COM) port 250 connected to and from a network connected thereto to facilitate data communications. The COM port 250 may establish connections between the computing device 200 and the user terminal (e.g., the user terminal 130), the positioning system 140, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the COM port 250 may be and/or include a standardized communication port, such as RS232, RS485, etc.

The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other types of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element (not shown in FIG. 2). The computing device 200 may also receive programming and data via network communications.

Merely for illustration, only one CPU/processor 220 is described in the computing device 200. However, it should be noted that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

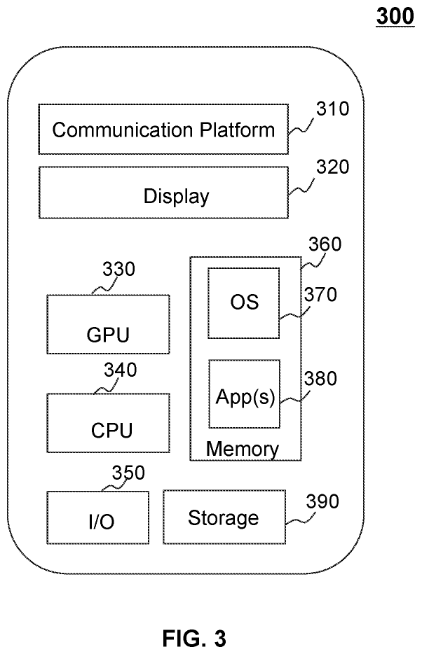

FIG. 3 is a schematic diagram illustrating exemplary hardware and/or software components of a mobile device on which a user terminal (e.g., the user terminal 130) may be implemented according to some embodiments of the present disclosure. As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The application(s) 380 (e.g., a taxi-hailing application) may include a browser or any other suitable mobile apps for receiving and rendering information relating to transportation services or other information from the processing device 112. User interactions with the information stream may be achieved via the I/O 350 and provided to the processing device 112 and/or other components of the LBS system 100 via the network 120. Merely by way of example, a user (e.g., a service requester) may input a start location through the I/O 350. As another example, a recommended pick-up location may be displayed and/or broadcast to the user via the I/O 350 and/or the display 320.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the LBS system 100 performs, the element may perform through electrical signals and/or electromagnetic signals. For example, when the processing device 112 processes a task, such as making a determination, or identifying information, the processing device 112 may operate logic circuits in its processor to process such task. When the processing device 112 receives data (e.g., a location of a service requester) from the user terminal (e.g., the user terminal 130), a processor of the processing device 112 may receive electrical signals encoding/including the data. The processor of the processing device 112 may receive the electrical signals through an input port. If the user terminal (e.g., the user terminal 130) communicates with the processing device 112 via a wired network, the input port may be physically connected to a cable. If the user terminal (e.g., the user terminal 130) communicates with the processing device 112 via a wireless network, the input port of the processing device 112 may be one or more antennas, which may convert the electrical signals to electromagnetic signals. Within an electronic device, such as the user terminal (e.g., the user terminal 130), and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

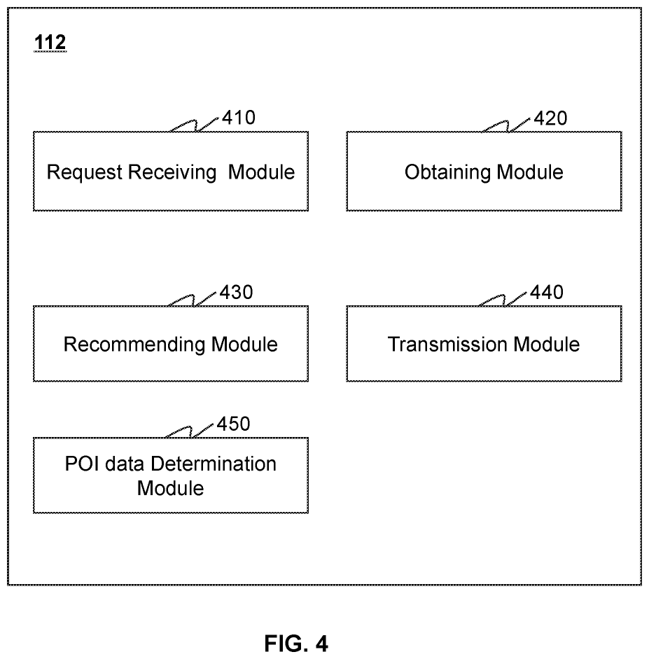

FIG. 4 is a schematic block diagram illustrating an exemplary processing device 112 according to some embodiments of the present disclosure. The processing device 112 may include a request receiving module 410, an obtaining module 420, a recommending module 430, a transmission module 440, and a POI data determination module 450.

The request receiving module 410 may be configured to receive a request for an LBS sent by a user via a user terminal (e. g., the user terminal 130). As used herein, an LBS may refer to any service related to location information. For illustration purposes, the LBS may include determining one or more recommended POIs so that the service can be properly provided. In some embodiments, the user may select one of the one or more POIs as a pick-up location of the user. As used herein, a pick-up location (i.e., start location) of a user may refer to a geographic location where the user gets on a vehicle. For example, if a user hails a vehicle, the user may wait for a driver of the vehicle at a pick-up location.

In some embodiments, the LBS may include a transportation service (for example, a taxi-hailing service, a chauffeur service, an express car service, a carpool service, a bus service, a driver hire service, and a shuttle service), a food order service, a navigation service, a location search service, a location input service, a positioning service, or the like, or any combination thereof.

The obtaining module 420 may be configured to obtain a start location based on the request for the LBS. In some embodiments, the user may initiate the request for the LBS by inputting the name of the start location via an interface of the user terminal. For example, the user may initiate the request for the LBS by inputting the name of a current location of the user. As another example, the user may initiate the request for the LBS and indicate the start location by inputting the name of a location where the user wants to get on a vehicle. In some embodiments, the user may input the name of the location via a typing interface, a hand gesturing interface, a voice interface, a picture interface of the mobile device, etc. For example, a user may input the name of a start location in a location input or search box of an interface of a user terminal via a typing interface.

In some embodiments, the obtaining module 420 may obtain the start location based on a positioning technology, and the start location may be the current location of the user. For example, the user may initiate the request for the LBS only by clicking a location input or search box of an interface of a user terminal. The obtaining module 420 may automatically obtain the current location of the user and designate the current location as the start location of the user.

The recommending module 430 may be configured to determine one or more recommended POIs based on the start location and POI data associated with the start location (e.g., POI data as illustrated in FIG. 8). As described above, the user may select one of the one or more recommend POIs as the pick-up location for the request for the LBS. In some embodiments, the recommending module 430 may obtain the POI data associated with the start location from a storage device (e.g., the storage device 150) disclosed elsewhere in the present disclosure.

In some embodiments, the recommending module 430 may determine the one or more recommended POIs based on a process described below. The recommending module 430 may determine a plurality of candidate POIs based on the start location. In some embodiments, the recommending module 430 may determine at least one of a prefix, a key term, or a phrase in the name of the start location and determine the plurality of candidate POIs based on the prefix, the key term, or the phrase.

Further, the recommending module 430 may rank at least a portion of the candidate POIs to produce a ranking result at least based on the POI data associated with the start location. In some embodiments, the recommending module 430 may rank all the candidate POIs. In some embodiments, the recommending module 430 may rank only a portion of the candidate POIs, e.g., after a filtering process that selects certain candidate POIs. In some embodiments, the recommending module 430 may rank the at least a portion of the candidate POIs based on popularity degrees thereof. In some embodiments, the recommending module 430 may rank the at least a portion of the candidate POIs from large to small or from small to large based on the popularity degrees. For example, the greater the popularity degree is, the higher the ranking of a corresponding candidate POI may be.

In some embodiments, the recommending module 430 may rank the at least a portion of the candidate POIs based on the popularity degrees thereof and a current location of the user. In some embodiments, the recommending module 430 may obtain a distance or an expected travel time between the current location and each of the at least a portion of the candidate POIs. The recommending module 430 may then rank the at least a portion of the candidate POIs based on the popularity degrees thereof and the distances or expected travel times.

In some embodiments, for each child POI, the recommending module 430 may determine whether a distance or an expected travel time between the current location and the child POI is smaller than a distance threshold or a time threshold. In response to a determination that the distance or the expected travel time is smaller than the distance threshold or the time threshold, the recommending module 430 may allocate at least one weight to the child POI. The recommending module 430 may rank the at least a portion of the candidate POIs based on the popularity degrees thereof and the weight(s). In some embodiments, for a child POI, a corresponding weight may make the child POI have a higher ranking. In response to the determination result that the distance or the expected travel time is greater than or equal to the distance threshold or the time threshold, the recommending module 430 may rank the at least a portion of the candidate POIs based on the popularity degrees and the distances or the expected travel times. For illustration purposes, the recommending module 430 may rank the at least a portion of the candidate POIs by comprehensively evaluating the popularity degrees and the distances or the expected travel times.

In some embodiments, other than the popularity degrees and/or the distances or the expected travel times, personalized information associated with the user also may be taken into consideration. For example, the greater a frequency that a POI was selected by the user as historical service locations (e.g., a historical pick-up location) in past time, the higher the ranking of the candidate POI may be. Further, the recommending module 430 may determine the one or more recommended POIs (e.g., TOP 1, TOP 3, TOP 5, TOP 10) based on the ranking result.

The transmission module 440 may be configured to transmit signals to the user terminal to display at least one of the one or more recommended POIs. In some embodiments, the transmission module 440 may rank only a portion of the one or more recommended POIs. In some embodiments, the transmission module 440 may transmit signals to the user terminal to display all the one or more recommended POIs. For illustration purposes, the at least one of the one or more recommended POIs may be displayed as a list that is close to the location input or search box of the interface of the user terminal. The user may further select a POI from the one or more recommended POIs as the pick-up location of the user.

The POI data determination module 450 may be configured to determine the POI data associated with the start location described above. In some embodiments, the POI data determination module 450 may obtain a plurality of historical transportation trip records, e.g., within a predetermined time period (e.g., the last month, the last three months, the last year). The POI data determination module 450 may obtain the plurality of historical transportation trip records from a storage device (e.g., the storage device 150), such as the ones disclosed elsewhere in the present disclosure.

In some embodiments, each of the plurality of historical transportation trip records may include a historical start location of a historical user, a historical location of the historical user, one or more historical POIs, a selected historical POI as a historical service location (e.g., a historical pick-up location) of the historical transportation trip record, or the like, or any combination thereof.

The POI data determination module 450 may determine a plurality of groups of historical POIs based on the historical start locations and the historical POIs. As used herein, each group of the plurality of groups of historical POIs may include a historical parent POI within a historical region and one or more historical child POIs within the historical region.

In some embodiments, the POI data determination module 450 may also determine at least one historical POI other than the historical parent POI and the one or more historical child POIs associated with the historical region. In some embodiments, a distance or an expected travel time between a historical POI of the at least one historical POI and the historical region (e.g., a center of the historical region) may be smaller than or equal to a distance threshold or the expected travel time.

In some embodiment, the POI data determination module 450 may obtain one or more supplementary groups of historical POIs and add them into the plurality of groups of historical POIs. In some embodiments, the POI data determination module 450 may obtain a plurality of second historical transportation trip records. Further, the POI data determination module 450 may obtain the one or more supplementary groups of historical POIs based on the process for determining the plurality of groups of historical POIs as illustrated above. In some embodiments, the POI data determination module 450 may obtain the one or more supplementary groups of historical POIs by searching data, e.g., current POI database (e.g., including a great number of POIs), urban planning data, road network data, etc.

The POI data determination module 450 may determine an initial historical popularity degree corresponding to each historical POI in the plurality of groups of historical POIs at least based on the selected historical POIs corresponding to the plurality of historical transportation trip records. As used herein, an initial historical popularity degree corresponding to a historical POI may refer to a probability that a user selects the historical POI as a service location (e.g., a pick-up location). The greater the initial historical popularity degree is, the more probably the user selects the historical POI as the service location (e.g., a pick-up location).

In some embodiments, for a historical POI, the POI data determination module 450 may determine a count of historical trip records whose selected historical POIs are the historical POI. The POI data determination module 450 may determine the initial historical popularity degree based on the count. In some embodiments, the initial historical popularity may be the count. In some embodiments, the initial historical popularity degree may be a ratio of the count to a total count of the historical transportation service trip records.

The POI data determination module 450 may adjust at least one of the initial historical popularity degrees corresponding to at least one historical POI based on the plurality of historical transportation trip records. As used herein, an adjusted historical popularity degree corresponding to a historical POI may more accurately indicate a probability that a historical user selects the historical POI as a historical pick-up location of the historical user.

In some embodiments, the POI data determination module 450 may adjust the at least one of the initial historical popularity degrees based on one or more historical transportation trip records whose selected historical POIs are historical parent POIs among the plurality of historical transportation trip records and generate at least one adjusted historical popularity degree.

In some embodiments, for each of the one or more historical transportation trip records, the POI data determination module 450 may determine one or more distances or expected travel times between a historical location of a historical user and one or more historical child POIs. The POI data determination module 450 may determine a historical child POI with the smallest distance of the one or more distances or the smallest expected travel time of the one or more expected travel times. Further, the POI data determination module 450 may determine a second count of each of the one or more historical child POIs with the smallest distance or the smallest expected travel time. The POI data determination module 450 may generate the at least one adjusted historical popularity degree based on the second count of the one or more child POIs with the smallest distance or the smallest expected travel time. In some embodiments, for a historical child POI, the POI data determination module 450 may generate a corresponding adjusted historical popularity degree by increasing a corresponding initial historical popularity degree based on a second count of the child POIs with the smallest distance or the smallest expected travel time. In some embodiments, the adjusted historical popularity degree may be a total of a count corresponding to the initial historical popularity degree and the second count. In some embodiments, the adjusted historical popularity degree may be a total of a ratio corresponding to the initial historical popularity degree and a second ratio determined based on the second count. As used herein, the second ratio may refer to a ratio of the second count to a count of historical transportation trip records whose selected historical POIs is a historical parent POI corresponding to the historical child POI. In some embodiments, after the adjustment, a historical popularity degree corresponding to a historical POI (e.g., a historical parent POI) other than the child POIs may remain the same, i.e., an initial historical popularity degree corresponding to the historical parent POI.

In some embodiments, for a historical POI, the POI data determination module 450 may determine one or more historical popularity degrees (e.g., an initial historical popularity degree, an adjusted historical popularity degree) that correspond to one or more time periods.

The POI data determination module 450 may determine the POI data associated with the start location based on the plurality of groups of historical POIs, the initial historical popularity degrees, and the at least one adjusted historical popularity degree (collectively referred to as “historical POI data”). In some embodiments, the POI data associated with the start location may include at least a portion of the historical data. For example, the start location may be a location in a city, the historical POI data may include data of a province including the city. The POI data associated with the start location may be a portion of the historical POI data. As another example, the start location may be a location in a city, the historical POI data may include data of the city. The POI data associated with the start location may be the historical data.

The modules in the processing device 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the processing device 112 may include a storage module (not shown) which may be used to store data generated by the above-mentioned modules, e.g., the start location, the POI data associated with the start location, the one or more recommended POIs, etc. As another example, the POI data determination module 450 may be unnecessary and the POI data associated with the start location may be obtained from a storage device (e.g., the storage device 150) disclosed elsewhere in the present disclosure or an external device in communication with the LBS system 100.

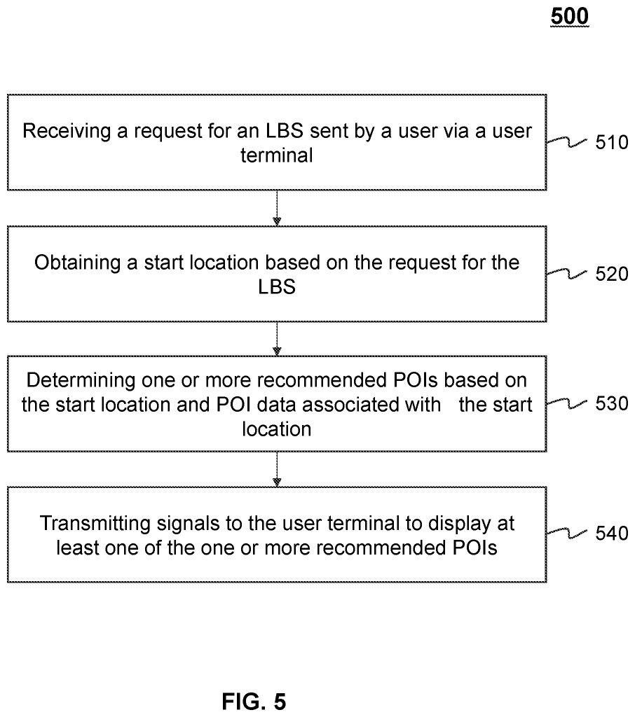

FIG. 5 is a flowchart illustrating an exemplary process for displaying one or more points of interest (POIs) of a location-based service (LBS) according to some embodiments of the present disclosure. In some embodiments, process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 500. The operations of the illustrated process presented below are intended to be illustrative. In some embodiments, process 500 may be accomplished with one or more additional operations not described and/or without one or more of the operations herein discussed. Additionally, the order in which the operations of the process as illustrated in FIG. 5 and described below is not intended to be limiting.

In 510, the processing device 112 (e.g., the request receiving module 410) may receive a request for an LBS sent by a user via a user terminal (e. g., the user terminal 130). As used herein, an LBS may refer to any service related to location information. For illustration purposes, the LBS may include determining one or more recommended POIs so that the service can be properly provided. In some embodiments, the user may select one of the one or more POIs as a pick-up location of the user. As used herein, a pick-up location (i.e. start location) of a user may refer to a geographic location where the user gets on a vehicle. For example, if a user hails a vehicle, the user may wait for a driver of the vehicle at a pick-up location. In some embodiments, the one or more recommended POIs can be destinations or transfer points of the user. It should be noted that the POIs being pick-up locations is used as examples for illustration purposes, such POIs can be destinations or transfer points as long as the process of determining the POIs does not contradict the basic business logic of the LBS. In some embodiments, the systems and methods herein described for determining recommended POIs for pick-up locations can be analogous or parallel systems and methods that can be used to determining recommended POIs for destinations.

In some embodiments, the LBS may include a transportation service (for example, a taxi-hailing service, a chauffeur service, an express car service, a carpool service, a bus service, a driver hire service, and a shuttle service), a food order service, a navigation service, a location search service, a location input service, a positioning service, or the like, or any combination thereof.

In 520, the processing device 112 (e.g., the obtaining module 420) may obtain a start location based on the request for the LBS. In some embodiments, the user may initiate the request for the LBS by inputting the name of the start location via an interface of the user terminal. For example, the user may initiate the request for the LBS by inputting the name of a current location of the user. As another example, the user may initiate the request for the LBS and indicate the start location by inputting the name of a location where the user wants to get on a vehicle. In some embodiments, the user may input the name of the location via a typing interface, a hand gesturing interface, a voice interface, a picture interface of the mobile device, etc. For example, a user may input the name of a start location in a location input or search box of an interface of a user terminal via a typing interface.

In some embodiments, the processing device 112 may obtain the start location based on a positioning system (e.g., the positioning system 140), and the start location may be the current location of the user. For example, the user may initiate the request for the LBS only by clicking a location input or search box of an interface of a user terminal. In some embodiments, the processing device 112 may automatically obtain the current location of the user and designate the current location as the start location of the user.

In 530, the processing device 112 (e.g., the recommending module 430) may determine one or more recommended POIs based on the start location and POI data associated with the start location (e.g., POI data as illustrated in FIG. 8). As described above, the user may select one of the one or more recommend POIs as the pick-up location for the request for the LBS.

In some embodiments, the POI data associated with the start location may include a plurality of groups of POIs and a plurality of popularity degrees, each corresponding to each POI of the plurality of groups of POIs. As used herein, a popularity degree corresponding to a POI may indicate a probability that a user selects the POI as a pick-up location of the user. In some embodiments, each group of the plurality of groups of POIs may include a parent POI within a region and one or more child POIs within the region. As used herein, a parent POI and a child POI may have a parent-child relationship. For example, the processing device 112 may designate a location of a shopping mall as a parent POI and a location of a gateway (e.g., an entrance, an exit) of the shopping mall as a child POI. As another example, the processing device 112 may designate a location of a shopping mall as a parent POI and the location of a shop of the shopping mall as a child POI.

In some embodiments, the region may be a geographic region that includes a plurality of gateways for entrances or exits. For illustration purposes, the geographic region may include a gated community, a housing estate, a train station, an airport, a shopping mall, a stadium, etc. In some embodiments, the POI data associated with the start location may at least include a group of POIs associated with the start location. For example, if the start location is associated with a shopping mall (e.g., within the shopping mall), the POI data associated with the start location may at least include a group of POIs within the shopping mall.

In some embodiments, the region may be regarded as an area within a geo-fence. As used herein, a geo-fence may refer to a virtual perimeter for a real-world geographic area. The processing device 112 may generate a signal indicating that the user enters or exit the geo-fence, which may facilitate the use of the POI data associated with the start location for recommending the one or more POIs.

In some embodiments, each group of the plurality of groups of POIs may also include at least one POI other than the parent POI and the one or more child POIs associated with the region and at least one popularity degree corresponding to the at least one POI. In some embodiments, a distance or an expected travel time between a POI of the at least one POI and the region (e.g., a center of the region) may be smaller than or equal to a distance threshold or a time threshold.

In some embodiments, each group of the plurality of groups of POIs may also include feature information. For illustration purposes, the feature information may include a parent-child relationship between POIs, status information of the parent POI (e.g., a train station, a mall, etc.), status information of the child POI (e.g., an entrance, an exit, etc.), or the like, or any combination thereof. In some embodiments, the POI data associated with the start location may also include personalized information. For example, the personalized information may include a frequency of a POI selected by the user as a pick-up location in past time.

In some embodiments, the POI data associated with the start location may be provided by the LBS system 100 (e.g., the processing device 112) or a third party (e.g., an external database). The LBS system 100 may predetermine the POI data associated with the start location offline and store the POI data associated with the start location in a storage device (e.g., the storage device 150) disclosed elsewhere in the present disclosure.

In some embodiments, the LBS system 100 may determine the POI data associated with the start location based on a plurality of historical transportation trip records. In some embodiments, the processing device 112 or the third party may determine the POI data associated with start location based on the plurality of historical transportation trip records and data such as current POI database, urban planning data, road network data.

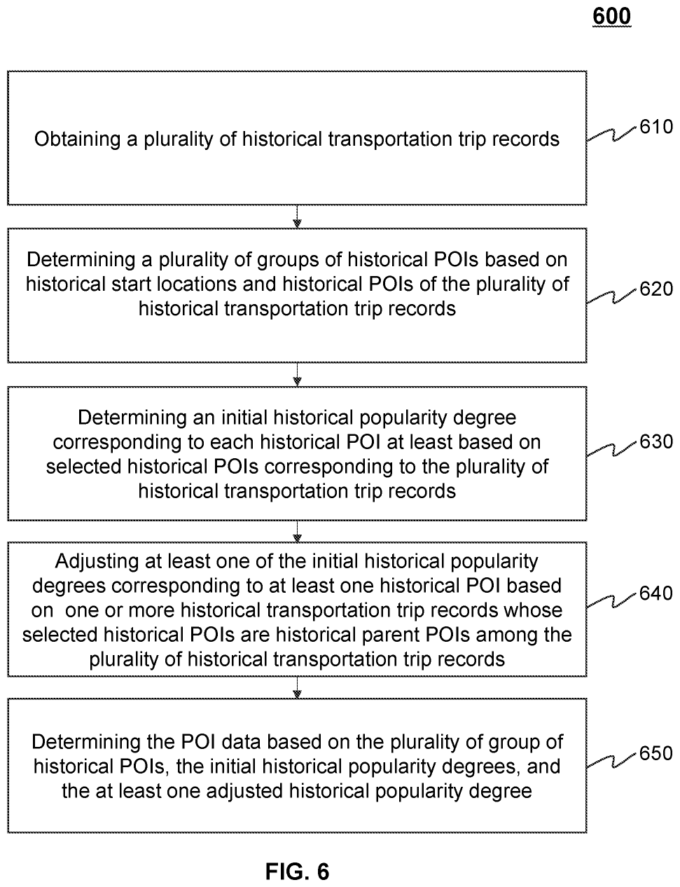

In some embodiments, each of the plurality of historical transportation trip records may include a historical start location of a historical user, a historical location of the historical user, one or more historical POIs, a selected historical POI as a historical service location (e.g., a historical pick-up location) of the historical transportation trip record, or the like, or any combination thereof. The LBS system 100 may determine a plurality of groups of historical POIs based at least on the historical start locations and the historical POIs. The LBS system 100 may also determine an initial historical popularity degree corresponding to each historical POI in the plurality of groups of historical POIs based at least on the selected historical POIs. As described elsewhere in the present disclosure, for some of the plurality of historical transportation trip records, a historical child POI may be more appropriate as a historical pick-up location than a corresponding historical parent POI. However, the historical child POI may be not one of the one or more historical POIs, the user may be unlikely to select the historical child POI as the historical pick-up location. In some cases, the user may select the historical parent POI as the historical pick-up location. As a result, a historical user may walk a longer distance to the historical parent POI than to the historical child POI, or to communicate with a historical driver of a historical vehicle to adjust the historical pick-up location, thus worsening user experience. To this end, the LBS system 100 may adjust at least one of the initial historical popularity degrees corresponding to at least one historical POI. As used herein, an adjusted historical popularity degree corresponding to a historical POI may more accurately indicate a probability that a historical user selects the historical POI as a historical pick-up location of the historical user. The popularity degree corresponding to the POI may be determined based at least on the adjusted historical popularity degrees. More detailed description can be found elsewhere in the present disclosure, e.g., FIG. 6 and the descriptions thereof.

In some embodiments, for the same POI, a popularity degree may be time-dependent, i.e., the popularity degree changes with time. For example, a gate of a region may open within a first time period and close within a second time period in a day. Accordingly, a popularity degree of the gate in the first time period may be greater than in the second time period. As another example, a popularity degree of a POI in rush hours may be different from in normal hours. In some embodiments, for a POI, the POI data associated with the start location may include one or more popularity degrees correspond to one or more time periods. In some embodiments, POI data corresponding to each of the one or more time periods may be stored separately. In some embodiments, the processing device 112 may select the POI data corresponding to each of the one or more time periods based on time. For example, when receiving an LBS from a particular time point during rush hours, the processing device 112 may select POI data corresponding to rush hours. In some embodiments, the processing device may switch the POI data corresponding to each of the one or more time periods based on current time (e.g., the time that the processing device 112 uses the POI data).

In some embodiments, the processing device 112 may determine the one or more recommended POIs based on a process described below. The processing device 112 may determine a plurality of candidate POIs based on the start location. In some embodiments, the processing device 112 may determine at least one of a prefix, a key term, or a phrase in the name of the start location and determine the plurality of candidate POIs based on the prefix, the key term, or the phrase. For example, if assuming that the name of the start location includes a key term “central business district,” the processing device 112 may determine a plurality of candidate POIs such as “Central Business District Subway Station,” “Central Business District Building,” etc.

Further, the processing device 112 may rank at least a portion of the candidate POIs to produce a ranking result based at least on the POI data associated with the start location. In some embodiments, the processing device 112 ranks all the candidate POIs. In some embodiments, the processing device 112 ranks only a portion of the candidate POIs, e.g., after a filtering process that selects certain candidate POIs. In some embodiments, the processing device 112 may rank the at least a portion of the candidate POIs based on popularity degrees thereof. In some embodiments, the processing device 112 may rank the at least a portion of the candidate POIs from large to small or from small to large based on the popularity degrees. For example, the greater the popularity degree is, the higher the ranking of a corresponding candidate POI may be.

In some embodiments, the processing device 112 may rank the at least a portion of the candidate POIs based on the popularity degrees thereof and a current location of the user. In some embodiments, the processing device 112 may obtain a distance or an expected travel time between the current location and each of the at least a portion of the candidate POIs. The processing device 112 may then rank the at least a portion of the candidate POIs based on the popularity degrees thereof and the distances or the expected travel times.

In some embodiments, for each child POI, the processing device 112 may determine whether a distance or an expected travel time between the current location and the child POI is smaller than a distance threshold or a time threshold. In response to a determination that the distance or the expected travel time is smaller than the distance threshold or the time threshold, the processing device 112 may allocate at least one weight to the child POI. The processing device 112 may rank the at least a portion of the candidate POIs based on the popularity degrees thereof and the weight(s). In some embodiments, for a child POI, a corresponding weight may make the child POI have a higher ranking. In some embodiments, the weight(s) may be default settings of the LBS system 100, or may be adjustable under different situations. In response to the determination result that the distance or the expected travel time is greater than or equal to the distance threshold or the time threshold, the processing device 112 may rank the at least a portion of the candidate POIs based on the popularity degrees and the distances or the expected travel times. For illustration purposes, the processing device 112 may rank the at least a portion of the candidate POIs by comprehensively evaluating the popularity degrees and the distances or the expected travel times.

In some embodiments, other than the popularity degrees and/or the distances or the expected travel times, personalized information associated with the user also may be taken into consideration. For example, the greater a frequency that a POI was selected by the user as historical service locations (e.g., a historical pick-up location) in past time, the higher the ranking of the candidate POI may be.

Further, the processing device 112 may determine the one or more recommended POIs (e.g., TOP 1, TOP 3, TOP 5, TOP 10) based on the ranking result. In 540, the processing device 112 (e.g., the transmission module 440) may transmit signals to the user terminal to display at least one of the one or more recommended POIs. In some embodiments, the processing device 112 may rank only a portion of the one or more recommended POIs. In some embodiments, the processing device 112 may transmit signals to the user terminal to display all the one or more recommended POIs. For illustration purposes, the at least one of the one or more recommended POIs may be displayed as a list that is close to the location input or search box of the interface of the user terminal. The user may further select a POI from the one or more recommended POIs as the pick-up location of the user.

It should be noted that while the start location and the pick-up location are used as examples for the present disclosure, the optimization of other types of locations can also utilize process 500 described above. For example, the processing device 112 may obtain a destination for an LBS, the processing device 112 may determine a drop-off location based on the destination and the POI data associated with the destination based on a process similar to process 500 described above.

It should also be noted that process 500 takes the POI data used in vehicle-hailing scenarios as an example, the POI data may be also used in other application scenarios similar to current POI database. For example, the POI data may be used for route planning, navigation, etc.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 6 is a flowchart illustrating an exemplary process for determining POI data associated with a start location according to some embodiments of the present disclosure. In some embodiments, process 600 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform process 600. The operations of the illustrated process presented below are intended to be illustrative. In some embodiments, process 600 may be accomplished with one or more additional operations not described and/or without one or more of the operations herein discussed. Additionally, the order in which the operations of the process as illustrated in FIG. 6 and described below is not intended to be limiting.

In 610, the processing device 112 (e.g., the POI data determination module 450) may obtain a plurality of historical transportation trip records, e.g., within a predetermined time period (e.g., the last month, the last three months, the last year). The processing device 112 may obtain the plurality of historical transportation trip records from a storage device (e.g., the storage device 150), such as the ones disclosed elsewhere in the present disclosure.

In some embodiments, each of the plurality of historical transportation trip records may include a historical start location of a historical user, a historical location of the historical user, one or more historical POIs, a selected historical POI as a historical service location (e.g., a historical pick-up location) of the historical transportation trip record, or the like, or any combination thereof. As used herein, a historical POI may refer to a POI recommended to the historical user (similar to the recommend POI as illustrated in FIG. 4). For each of the plurality of historical transportation trip records, at least one of the one or more historical POIs was transmitted to the user and the user selected one of the one or more historical POIs as the historical service location. Similar to the start location as illustrated in FIG. 4, the name of the historical start location may be input by the historical user or determined by the positioning system. In some embodiments, the historical start location may be the location of the historical user.

In 620, the processing device 112 (e.g., the POI data determination module 450) may determine a plurality of groups of historical POIs based on the historical start locations and the historical POIs. As used herein, each group of the plurality of groups of historical POIs may include a historical parent POI within a historical region and one or more historical child POIs within the historical region. Similar to the parent POI and the child POI, a historical parent POI and a historical child POI may have a parent-child relationship. For example, the processing device 112 may designate a location of a shopping mall as a historical parent POI and a location of a gateway (e.g., an entrance, an exit) of the shopping mall as a historical child POI. As another example, the processing device 112 may designate a location of a shopping mall as a historical parent POI and the location of a shop of the shopping mall as a historical child POI.

Accordingly, the processing device 112 may determine the plurality of groups of historical POIs based on historical POIs having a parent-child relationship. For illustration purposes, the processing device 112 may classify historical child POIs with the same parent POI and the parent POI into a group of historical POIs. In some embodiments, if two historical POIs have the parent-child relationship, the two historical POIs may be in the same historical region, and similarity between key terms of the two historical POIs may be greater than a threshold (e.g., 0.8). As used herein, a key term of a historical POI may refer to a term indicating a name of a historical region. For example, the key term may include a name of a gated community, a name of a housing estate, a name of a train station, a name of an airport, a name of a shopping mall, a name of a stadium, etc.

As used herein, the historical region may be a geographic region that includes a plurality of gateways for entrances or exits. For illustration purposes, the geographic region may include a gated community, a housing estate, a train station, an airport, a shopping mall, a stadium, etc.

In some embodiments, the processing device 112 may also determine at least one historical POI other than the historical parent POI and the one or more historical child POIs associated with the historical region. In some embodiments, a distance or an expected travel time between a historical POI of the at least one historical POI and the historical region (e.g., a center of the historical region) may be smaller than or equal to a distance threshold or a time threshold.

In some embodiment, the processing device 112 may obtain one or more supplementary groups of historical POIs and add them into the plurality of groups of historical POIs. In some embodiments, the processing device 112 may obtain a plurality of second historical transportation trip records. Similar to the plurality of first historical transportation trip records, each of the plurality of second historical transportation trip records may include a second historical start location of a second historical user, a second historical location of the second historical user, one or more second historical POIs, a second selected historical POI as a second historical service location (e.g., a second historical pick-up location) of the second historical transportation trip record, or the like, or any combination thereof. Further, the processing device 112 may obtain the one or more supplementary groups of historical POIs based on the process for determining the plurality of groups of historical POIs as illustrated above. In some embodiments, the processing device 112 may obtain the one or more supplementary groups of historical POIs by searching data, e.g., current POI database (e.g., including a great number of POIs), urban planning data, road network data, etc.

In 630, the processing device 112 (e.g., the POI data determination module 450) may determine an initial historical popularity degree corresponding to each historical POI in the plurality of groups of historical POIs based at least on the selected historical POIs. As used herein, an initial historical popularity degree corresponding to a historical POI may refer to a probability that a user selects the historical POI as a service location (e.g., a pick-up location). The greater the initial historical popularity degree is, the more probably the user selects the historical POI as the service location (e.g., a pick-up location).

In some embodiments, for a historical POI, the processing device 112 may determine a count of historical trip records whose selected historical POIs are the historical POI. The processing device 112 may determine the initial historical popularity degree based on the count. In some embodiments, the initial historical popularity may be the count. In some embodiments, the initial historical popularity degree may be a ratio of the count to a total count of the historical transportation service trip records.

In 640, the processing device 112 (e.g., the POI data determination module 450) may adjust at least one of the initial historical popularity degrees corresponding to at least one historical POI based on the plurality of historical transportation trip records. As described elsewhere in the present disclosure, for some of the plurality of historical transportation trip records, a historical child POI may be more appropriate as a historical pick-up location than a corresponding historical parent POI. However, the historical child POI may be not one of the one or more historical POIs, the user may be unlikely to select the historical child POI as the historical pick-up location. In some cases, the user may select the historical parent POI as the historical pick-up location. As a result, a historical user may walk a longer distance to the historical parent POI than to the historical child POI, or to communicate with a historical driver of a historical vehicle to adjust the historical pick-up location, thus worsening user experience. To this end, the processing device 112 may adjust the at least one of the initial historical popularity degrees corresponding to at least one historical POI. As used herein, an adjusted historical popularity degree corresponding to a historical POI may more accurately indicate a probability that a historical user selects the historical POI as a historical pick-up location of the historical user.

In some embodiments, the processing device 112 may adjust the at least one of the initial historical popularity degrees based on one or more historical transportation trip records whose selected historical POIs are historical parent POIs among the plurality of historical transportation trip records and generate at least one adjusted historical popularity degree.

In some embodiments, for each of the one or more historical transportation trip records, the processing device 112 may determine one or more distances or expected travel times between a historical location of a historical user and one or more historical child POIs. The processing device 112 may determine a historical child POI with the smallest distance of the one or more distances or the smallest expected travel time of the one or more expected travel times. Further, the processing device 112 may determine a second count of each of the one or more historical child POIs with the smallest distance or the smallest expected travel time. The processing device 112 may generate the at least one adjusted historical popularity degree based on the second count of the one or more child POIs with the smallest distance or the smallest expected travel time. In some embodiments, for a historical child POI, the processing device 112 may generate a corresponding adjusted historical popularity degree by increasing a corresponding initial historical popularity degree based on a second count of the child POIs with the smallest distance or the smallest expected travel time. In some embodiments, the adjusted historical popularity degree may be a total of a count corresponding to the initial historical popularity degree and the second count. In some embodiments, the adjusted historical popularity degree may be a total of a ratio corresponding to the initial historical popularity degree and a second ratio determined based on the second count. As used herein, the second ratio may refer to a ratio of the second count to a count of historical transportation trip records whose selected historical POIs are a historical parent POI corresponding to the historical child POI. In some embodiments, after the adjustment, a historical popularity degree corresponding to a historical POI (e.g., a historical parent POI) other than the child POIs may remain the same, i.e., an initial historical popularity degree corresponding to the historical parent POI.

In some embodiments, the initial historical popularity degree and the adjusted historical popularity degree may be time-dependent, i.e., the initial historical popularity degree and the adjusted historical popularity degree changes with time. For example, a gate of a region may open within a first time period and close within a second time period in a day. Accordingly, an initial historical popularity degree and/or an adjusted historical popularity degree of the gate in the first time period may be greater than in the second time period. As another example, a historical popularity degree of a historical POI in rush hours may be different from in normal hours. In some embodiments, for a historical POI, the processing device 112 may determine one or more popularity degrees (e.g., an initial popularity degree, an adjusted historical popularity degree) that correspond to one or more time periods.

In some embodiments, the processing device 112 may determine historical feature information and/or historical personalized information based on the plurality of historical transportation trip records. For illustration purposes, the historical feature information may include a parent-child relationship between historical POIs, status information of the historical parent POI (e.g., a train station, a mall, etc.), status information of the historical child POI (e.g., an entrance, an exit, etc.), or the like, or any combination thereof. The historical personalized information may include a frequency of a historical POI selected by a historical user as a historical pick-up location.

In 650, the processing device 112 (e.g., the POI data determination module 450) may determine the POI data associated with based on the plurality of group of historical POIs, the initial historical popularity degrees, and the at least one adjusted historical popularity degree (collectively referred to as “historical POI data”). In some embodiments, the POI data associated with the start location may be the historical POI data. In some embodiments, the POI data associated with the start location may include at least a portion of the historical POI data. For example, the start location may be a location in a city, the historical POI data may include data of a province including the city. The POI data associated with the start location may be a portion of the historical POI data. As another example, the start location may be a location in a city, the historical POI data may include data of the city. The POI data associated with the start location may be the historical POI data.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the processing device 112 may determine at least a portion of the historical parent POIs and the historical child POIs by searching data (e.g., current POI database, urban planning data, road network data, etc.) in 610. The processing device 112 may obtain the plurality of historical transportation trip records in 620. Further, the processing device 112 may determine the initial historical popularity degrees and the at least one adjusted historical popularity degree at least based on the plurality of historical transportation trip records. As another example, the processing device 112 may obtain at least a portion of the plurality of historical transportation trip records and the initial historical popularity degree corresponding to each historical POI from a third party (e.g., current POI database). Further, the processing device 112 may determine the at least one adjusted historical popularity degree based on the initial historical popularity degrees and the plurality of historical transportation trip records. As a further example, the processing device 112 may update the historical POI data and/or the POI data associated with the start location at a certain time interval (e.g., per month, per two months) based on a plurality of newly obtained historical transportation trip records.

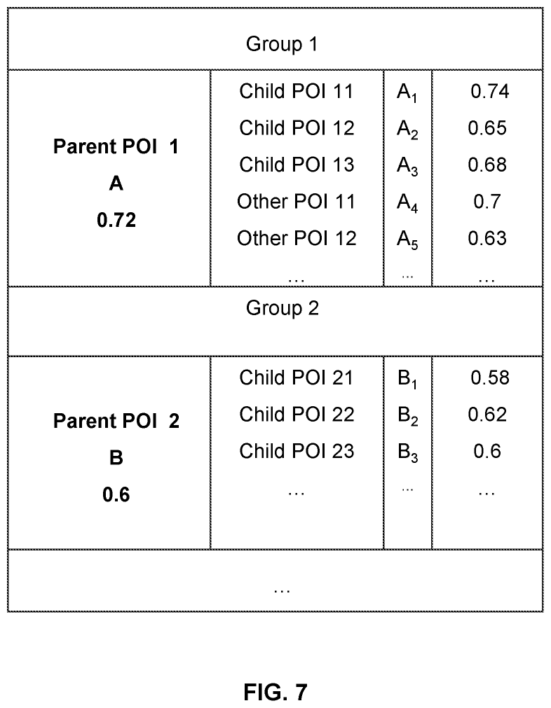

FIG. 7 is a schematic diagram of exemplary POI data according to some embodiments of the present disclosure.

As shown in FIG. 7, group 1 and group 2 may represent two exemplary groups of the plurality of groups of POIs as illustrated in FIGS. 5-6. Parent POI 1 may represent a parent POI in the group 1. A may refer a name of the parent POI 1. 0.72 may refer to a popularity degree of the parent POI 1. Similarly, parent POI 2 may represent a parent POI in the group 2. B may refer to a name of the parent POI 2. 0.6 may refer to a popularity degree of the parent POI 1.

As shown in FIG. 7, the group 1 may include five child POIs, i.e., child POI 11, child POI 12, child POI 13, other POI 11, and other POI 12. Names of the five child POIs may be A₁, A₂, A₃, A₄, and A₅, respectively. Popularity degrees of the five child POIs may be 0.74, 0.65, 0.68, 0.7, and 0.63, respectively. Similarly, the group 2 may include three child POIs, i.e., child POI 21, child POI 22, and child POI 23. Names of the three child POIs may be B₁, B₂, and B₃, respectively. Popularity degrees of the three child POIs may be 0.58, 0.62, and 0.6, respectively.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a specific feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the specific features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system configured to display one or more points of interest (POIs) of a location-based service (LBS), comprising:
at least one storage medium including a set of instructions; and
at least one processor in communication with the at least one storage medium, wherein when executing the set of instructions, the at least one processor is directed to:
receive a request for an LBS sent by a user via a user terminal;
obtain a start location based on the request for the LBS;
determine one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and
transmit signals to the user terminal to display at least one of the one or more recommended POIs.

2. The system of claim 1, wherein the POI data associated with the start location is provided by:
obtaining a plurality of historical transportation trip records, wherein each of the plurality of historical transportation trip records includes a historical start location of a historical user, a historical location of the historical user, one or more historical POIs, and a selected historical POI as a historical service location of the historical transportation trip record;
determining a plurality of groups of historical POIs based on the historical start locations and the historical POIs, wherein each group of the plurality of groups of historical POIs includes a historical parent POI within a historical region and one or more historical child POIs within the historical region;
determining an initial historical popularity degree corresponding to each historical POI at least based on the selected historical POIs corresponding to the plurality of historical transportation trip records;
adjusting at least one of the initial historical popularity degrees corresponding to at least one historical POI based on one or more historical transportation trip records whose selected historical POIs are historical parent POIs among the plurality of historical transportation trip records and generating at least one adjusted historical popularity degree; and
determining the POI data associated with the start location based on the plurality of groups of historical POIs, the initial historical popularity degrees, and the at least one adjusted historical popularity degree.

3. The system of claim 2, wherein the adjusting at least one of the initial historical popularity degrees corresponding to at least one historical POI of the plurality of groups of historical POIs based on one or more historical transportation trip records whose selected historical POIs are historical parent POIs among the plurality of historical transportation trip records and generating at least one adjusted historical popularity degree includes:
for each of the one or more historical transportation trip records,
determining one or more distances between a historical location of a historical user and one or more historical child POIs; and
determining a historical child POI with a smallest distance of the one or more distances;
determining a count of each of the one or more historical child POIs with the smallest distance; and
generating the at least one adjusted historical popularity degree based on the count of the one or more child POIs with the smallest distance.

4. The system of claim 1, wherein the POI data associated with the start location further includes at least one POI other than the parent POI and the one or more child POIs associated with the region and at least one popularity degree corresponding to the at least one POI of each of the plurality of groups of POIs.

5. The system of claim 1, wherein the POI data associated with the start location further includes feature information of each of the plurality of groups of POIs.

6. The system of claim 1, wherein the at least one processor is further directed to:
obtain one or more supplementary groups of POIs; and
add the one or more supplementary groups of POIs to the plurality of groups of POIs.

7. The system of claim 1, wherein to recommend the one or more POIs based on the current location and POI data associated with the start location, the at least processor is directed to:
determine a plurality of candidate POIs based on the start location;
rank at least a portion of the candidate POIs to produce a ranking result at least based on the POI data associated with the start location; and
determine the one or more recommended POIs based on the ranking result.

8. The system of claim 7, wherein to rank at least a portion of the candidate POIs to produce a ranking result at least based on the POI data associated with the start location, the at least one processor is further directed to:
obtain a current location of the user;
obtain a distance between the current location and each of the at least a portion of the candidate POIs;
rank the at least a portion of the candidate POIs to produce a ranking result based on the POI data associated with the start location and the distances.

9. The system of claim 8, wherein the at least a portion of candidate POIs include one of the parent POIs and at least one child POI corresponding to the parent POI, the at least one processor is further directed to:
rank the at least a portion of the candidate POIs to produce a ranking result based on the POI data associated with the start location and the distances, the at least one processor is directed to:
determine whether at least one distance between the current location and at least one of the at least one child POI is smaller than a distance threshold and to generate a determination result; and
rank the at least a portion of the candidate POIs to produce the ranking result based on the determination result and the POI data associated with the start location.

10. The system of claim 9, wherein the determination result includes the at least one distance between the current location and the at least one of the at least one child POI being smaller than the distance threshold, and
to rank the at least a portion of the candidate POIs to produce the ranking result based on the determination result and the POI data associated with the start location, the at least one processor is further directed to:
allocate at least one weight to the at least one of the at least one child POI; and
rank the at least a portion of the candidate POIs to produce the ranking result at least based on the at least one weight and the POI data associated with the start location.

11. The system of claim 1, wherein the at least one processor is further directed to receive signals indicating that one of the one or more recommend POIs is selected as a pick-up location for the request for the LBS by the user.

12. A method implemented on a computing device having at least one processor, at least one storage medium, and a communication platform connected to a network, the method comprising:
receiving a request for an LBS sent by a user via a user terminal;
obtaining a start location based on the request for the LBS;
determining one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and
transmitting signals to the user terminal to display at least one of the one or more recommended POIs.

13. The method of claim 12, wherein the POI data associated with the start location is provided by:
obtaining a plurality of historical transportation trip records, wherein each of the plurality of historical transportation trip records includes a historical start location of a historical user, a historical location of the historical user, one or more historical POIs, and a selected historical POI as a historical service location of the historical transportation trip record;
determining a plurality of groups of historical POIs based on the historical start locations and the historical POIs, wherein each group of the plurality of groups of historical POIs includes a historical parent POI within a historical region and one or more historical child POIs within the historical region;
determining an initial historical popularity degree corresponding to each historical POI at least based on the selected historical POIs corresponding to the plurality of historical transportation trip records;
adjusting at least one of the initial historical popularity degrees corresponding to at least one historical POI based on one or more historical transportation trip records whose selected historical POIs are historical parent POIs among the plurality of historical transportation trip records and generating at least one adjusted historical popularity degree; and
determining the POI data associated with the start location based on the plurality of groups of historical POIs, the initial historical popularity degrees, and the at least one adjusted historical popularity degree.

14. The method of claim 13, wherein the adjusting at least one of the initial historical popularity degrees corresponding to at least one historical POI of the plurality of groups of historical POIs based on one or more historical transportation trip records whose selected historical POIs are historical parent POIs among the plurality of historical transportation trip records and generating at least one adjusted historical popularity degree includes:
for each of the one or more historical transportation trip records,
determining one or more distances between a historical location of a historical user and one or more historical child POIs; and
determining a historical child POI with a smallest distance of the one or more distances;
determining a count of each of the one or more historical child POIs with the smallest distance; and
generating the at least one adjusted historical popularity degree based on the count of the one or more child POIs with the smallest distance.

15. (canceled)

16. (canceled)

17. The method of claim 12, further comprising:
obtaining one or more supplementary groups of POIs; and
adding the one or more supplementary groups of POIs to the plurality of groups of POIs.

18. The method of claim 12, wherein the recommending the one or more POIs based on the current location and POI data associated with the start location includes:
determining a plurality of candidate POIs based on the start location;
ranking at least a portion of the candidate POIs to produce a ranking result at least based on the POI data associated with the start location; and
determining the one or more recommended POIs based on the ranking result.

19. The method of claim 18, wherein the ranking at least a portion of the candidate POIs to produce a ranking result at least based on the POI data associated with the start location includes:
obtaining a current location of the user;
obtaining a distance between the current location and each of the at least a portion of the candidate POIs; and
ranking the at least a portion of the candidate POIs to produce a ranking result based on the POI data associated with the start location and the distances.

20. The method of claim 19, wherein the at least a portion of candidate POIs include one of the parent POIs and at least one child POI corresponding to the parent POI, the method further includes:
ranking the at least a portion of the candidate POIs to produce a ranking result based on the POI data associated with the start location and the distances, wherein the method includes:
determining whether at least one distance between the current location and at least one of the at least one child POI is smaller than a distance threshold and to generate a determination result; and
ranking the at least a portion of the candidate POIs to produce the ranking result based on the determination result and the POI data associated with the start location.

21. The method of claim 20, wherein the determination result includes the at least one distance between the current location and the at least one of the at least one child POI being smaller than the distance threshold, and
the ranking the at least a portion of the candidate POIs to produce the ranking result based on the determination result and the POI data associated with the start location includes:
allocating at least one weight to the at least one of the at least one child POI; and
ranking the at least a portion of the candidate POIs to produce the ranking result at least based on the at least one weight and the POI data associated with the start location.

22. (canceled)

23. A non-transitory computer readable medium, comprising executable instructions that, when executed by at least one processor, causing the at least one processor to effectuate a method comprising:
receiving a request for an LBS sent by a user via a user terminal;
obtaining a start location based on the request for the LBS;
determining one or more recommended POIs based on the start location and POI data associated with the start location, wherein the POI data associated with the start location includes a plurality of groups of POIs and a popularity degree corresponding to each POI of the plurality of groups of POIs, and each group of the plurality of groups of POIs includes a parent POI within a region and one or more child POIs within the region; and
transmitting signals to the user terminal to display at least one of the one or more recommended POIs.
